(19) United States
(12) Patent Application Publication
(10) Pub. No.: US 2010/0085968 A1
(43) Pub. Date: Apr. 8, 2010

(54) Routing Data in a Computing Device

(75) Inventor: Patrik Bannura, Staffanstorp (SE)

Correspondence Address: Saul Ewing LLP (Philadelphia), Attn: Patent Docket Clerk, 2 North Second St., Harrisburg, PA, 17101, US

(73) Assignee: SYMBIAN SOFTWARE LIMITED, London (UK)

(21) Appl. No.: 11/994,024

(22) PCT Filed: Jun. 29, 2006
(86) PCT No.: PCT/GB2006/002396

§ 371 Date: Jul. 21, 2008

(30) Foreign Application Priority Data
Jun. 29, 2005 (GB) 0513316.0

(51) Int. Cl. H04L 12/56

(52) U.S. Cl. 370/392

(57) ABSTRACT

A computing device comprises an architecture 30 having a number of network connections which independently connect to different LANs and which each independently and separately allocate private IP addresses. The device includes an interface manager 32 which functions to apply a unique network ID extension (NID) to the network address for an incoming data packet to avoid ambiguities arising when any one or more of the different LANs unknowingly duplicates the private IP addresses used by one or more of the other LANs. The associations between the NIDs, the networks and the interfaces can be stored on any suitable storage means within the device, such as a hard disc drive 34. For an outgoing data packet, the applied NID is stripped from the packet by the interface manager 32 before being routed to a network connection and exiting the device onto one of the connected LANs.

This invention relates to a method for operating a computing device, and in particular to a method of routing data in a computing device whereby internet Protocol private network addresses are processed such that an ambiguity problem arising from the way that private internet addresses are specified can be obviated.

The Internet connects many different computing devices worldwide using the Internet Protocol (IP). This protocol requires each connected entity to have a unique address. In version 4 of the Internet Protocol (IPv4) these are 32-bit numbers usually expressed as decimal versions of the hexadecimal representation of the number in the form n.n.n.n where n is a number between 0 and 255. As an example, the address corresponding to 439041101 decimal, which corresponds to 1A2B3C4D in hexadecimal, would in practice be written as 26.43.60.77.

The Internet Assigned Numbers Authority (IANA) is responsible for allocating IP addresses. However, certain IPv4 addresses are designated as private by the IANA, and can be used by anyone without applying for permission. They are intended for use in Local Area Networks (LANs). While they have to be uniquely associated with specific computing devices within any local network using Internet Protocols, they are not, and do not have to be, globally unique. It is common for private IP addresses on a LAN to be allocated to computing devices when they first connect to the network by means of a special server running the Dynamic Host Configuration Protocol (DHCP).

The IP ranges set aside for private use are 10.x.x.x, 172.16.0.0 to 172.32.255.255 and 192.168.x.x. and it is generally assumed that there is no possibility of these network addresses producing ambiguities as long as the addressable entities within each LAN are invisible to the outside world.

However, the above principles regarding the use of private IP addresses is deficient as it applies to computing devices which maintain multiple separate connections to different LANs over different network interfaces.

Where this is the case, it is quite possible for the DHCP servers on each of the LANs to unknowingly allocate identical private IP addresses to separate entities which are both visible at the same time.

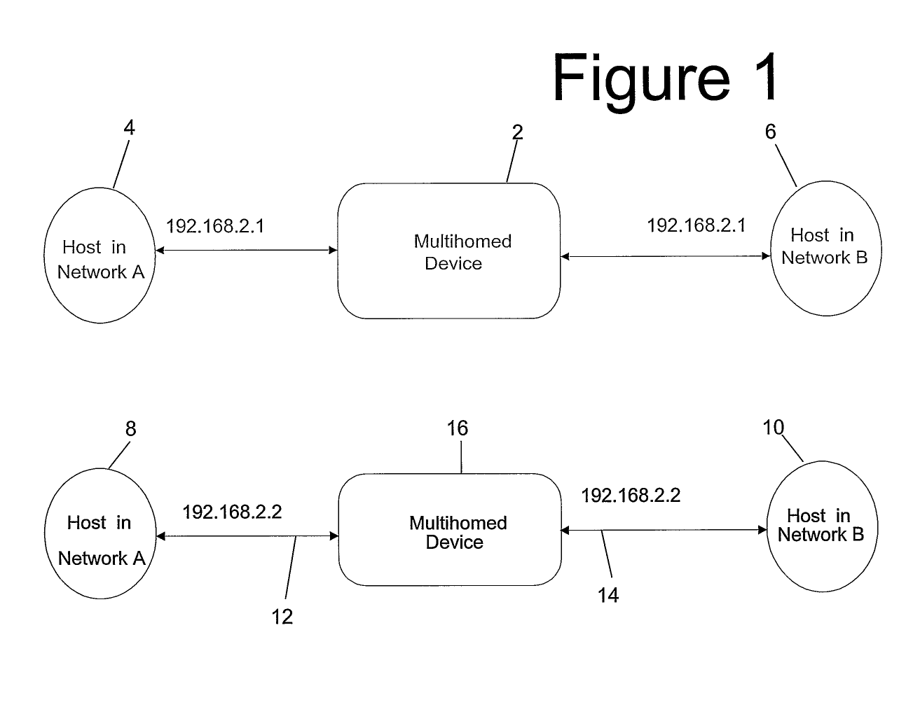

In such a scenario, an example of which is shown in FIG. 1, where there is a single IP protocol stack with packets routed by means of standard IPv4 addresses, it is clear that the assumption that private IP addresses do not generate ambiguity does not hold. In particular, it can be seen that FIG. 1 shows how a single device 2 addressing an outgoing packet to private address 192.168.2.1 would be unable to tell whether the packet should be routed to a host 4 in network A or a host 6 in network B. FIG. 1 further shows how hosts 8 and 10, which are located respectively in networks A and B, can both allocate the same private address 192.168.2.2 to two different interfaces 12 and 14 on the same device 16, making it impossible for a single IP protocol stack to route incoming packets to the correct internal connection.

The situation where a computing device is allocated identical addresses by two separate DHCP servers can be remedied by simply requesting one of the DHCP servers to allocate a different address; this is allowed for in the relevant standards. However, there is no method of ensuring with the known technology, when connecting to two different LANs, that the private addresses on each network will be unique.

This problem can in theory affect any computing device with multiple separate network connections to different LANs, such as a personal computer with two separate network cards, each connected to a separate local network. However, the most significant impact of this problem is its manifestation in network terminals attached to wireless networks such as mobile telephone networks specified by the Third Generation Partnership Project (3GPP). Those skilled in the art will be aware that the relevant specifications devised by this international standards body can be found at http://www.3gpp.org; an alternative set of specifications for 3G wireless networks has also been devised by the Third Generation Partnership Project 2 (3GPP2) and can be found at http://www.3gpp2.org.

A device attached to a wireless network is known as a Mobile Station (MS). While mobile telephones currently comprise the most numerous of these devices, they are not the only type that may be attached to such a network. Device convergence means that not just phones and portable computers, but also personal digital assistants (PDAs), games consoles, music players (such as MP3 players) and video players (such as DVD players) are becoming equipped with the facility to access wireless communication networks. These developments are to be expected, because 3G wireless networks are specifically aimed at providing fast data access, allowing streaming music and video, together with the predictable real-time performance required for modern interactive gaming.

A Mobile Station which is connected to a particular service on the network (such as Internet or WAP) is allowed to maintain multiple data streams in relation to that service; usually, data streams will belong to separate applications running in the computing device. Each of these data streams can be specified as requiring a particular network characteristic and can require different bandwidth requirements. For example, a single Mobile Station may be maintaining simultaneously a relatively high priority video stream that requires high bandwidth together with another lower priority lower bandwidth stream dedicated to background downloading of e-mail, which needs no more than a best effort service. Any such data stream opened by an application is called a PDP Context in the 3GPP specifications (where PDP is an acronym for Packet Data Protocol.) Each PDP context represents a standard network connection, and will generally have its own IP address.

Where two or more PDP contexts connect to LANs with different DHCP servers, as might be the case for the above example of simultaneous video and e-mail, the same IP address range can appear in more than one network simultaneously and this leads to ambiguity in operation. The assumption, therefore, that as long as the use of private IP addresses remains with a LAN then no ambiguity can arise is clearly not in fact correct.

This ambiguity problem cannot be solved by technologies such as Network Address Translation (NAT) which is commonly used to insulate private IP addresses from global IP addresses; typically, NAT is implemented in a gateway device which routes packets coming into a LAN from outside, or leaving the LAN for an outside destination by wrapping the packet data inside an IP wrapper that uses a single global IP address. NAT cannot solve problems with packets that appear to route entirely within the LAN, and hence cannot solve the source address ambiguity described above.

Therefore, it is an object of the present invention to provide a solution to the concerns of private address ambiguity by extending the IP address through the use of an extra network ID (NID) which is unique to each interface (or PDP context) on a device; this serves to make each address unique.

According to a first aspect of the present invention there is provided a method of providing Internet Protocol private network addresses on a computing device which maintains multiple interfaces, each of which may be connected to different local area networks, the method comprising embedding a respective unique identifier for each of the said local area networks in the Internet Protocol address structure.

According to a second aspect of the present invention there is provided a computing device arranged to operate in accordance with the method of the first aspect.

According to a third aspect of the present invention there is provided an operating system for causing a computing device to operate in accordance with the method of the first aspect.

Embodiments of the present invention will now be described, by way of further example only, with reference to the accompanying drawings, in which:—

FIG. 1 shows an example of an IP protocol stack with internet address ambiguity;

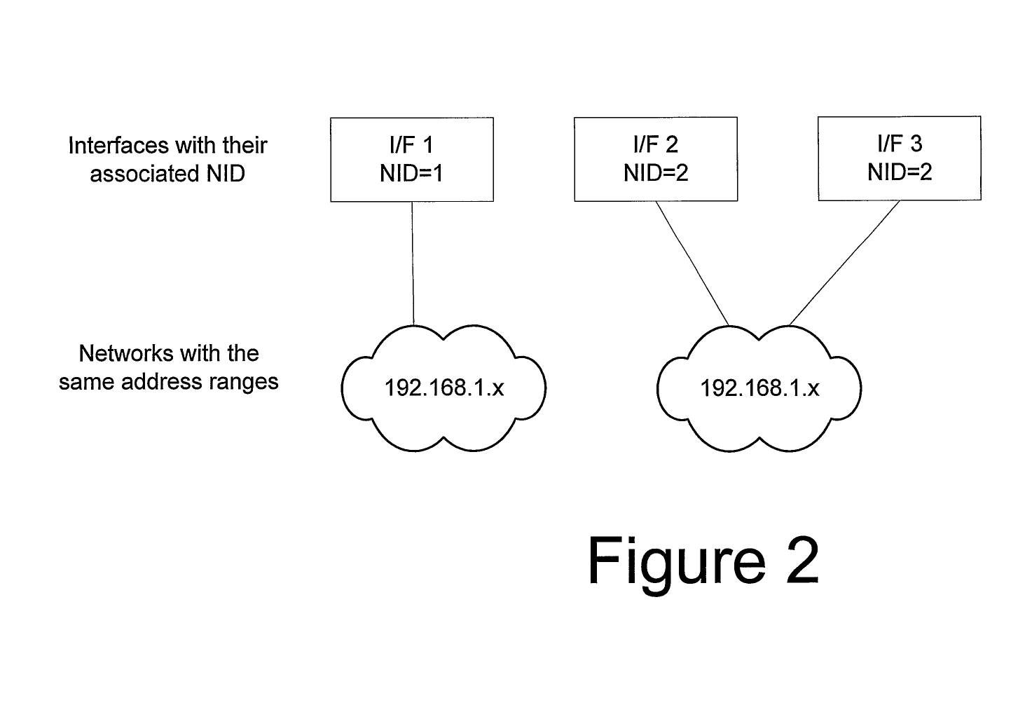

FIG. 2 shows an example of a configuration of two networks within a common address range in which one of the networks has a unique interface and the other of the networks has two interfaces; and

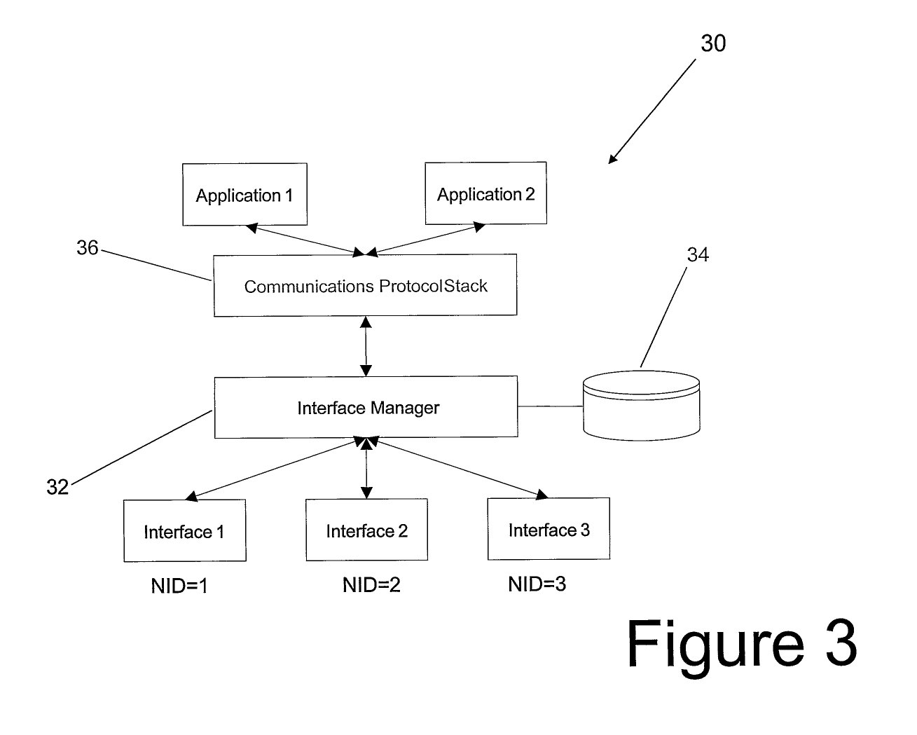

FIG. 3 shows a computing device architecture incorporating the present invention.

In essence, the present invention ensures that no ambiguity exists between private addresses through the addition of a network ID (NID) which is unique to each interface on a device. This NID is only internal to the device and is not used on the network. It is embedded in the IP address structure and so, from the point of view of an application running on the device, it is part of the address to be contacted; to which a data packet is to be routed.

An application on a device can also specify a NID to make the IP stack route packets to the specified network according to NID as well as IP address. Using the same NID can, therefore, allow representation of multiple points of attachment to the same network.

In a preferred implementation of this invention, the complete on-device address is represented by an IP socket structure containing the address, the device port identity and the NID. This structure can be used by applications to represent hosts on the network. An example of such a socket structure including the Network ID could be as follows:

| | | | | | |
|---|---|---|---|---|---|
| src addr | src port | dst addr | dst port | NID = 2 | Data |

| | | | |
|---|---|---|---|
| 192.168.1.2 | 66 | 192.168.1.1 | 66 |

In this implementation, a database stored on the computing device contains information about which interfaces connect to which networks. If more than one interface is attached to the same network each is associated with the same NID. Such a configuration is shown in FIG. 2, where network interface I/F 1 of network A, is allocated NID 1 whereas the interfaces I/F 2 and I/F 3 which both connect with network B that has the same network address as network A, are both allocated a common NID, namely NID 2.

For incoming traffic the NID is added to the socket structure in the TCP/IP stack once it is read from an interface. The following is an example of this transformation of incoming data packets.

A packet arriving at a device incorporating the present invention can typically be represented as follows:

| src addr | src port | dst addr | dst port | Data |
|---|---|---|---|---|
| 192.168.1.2 | 66 | 192.168.1.1 | 66 | |

where:
src addr indicates the source address
src port indicates the source port
dst addr indicates the destination address; and
dst port indicates the destination port.

However, the same packet is delivered to the application as follows, with the addition of the network ID:

| | | | | | |
|---|---|---|---|---|---|
| src addr | src port | dst addr | dst port | NID = 2 | Data |

| | | | |
|---|---|---|---|
| 192.168.1.2 | 66 | 192.168.1.1 | 66 |

When an application sends outgoing traffic, it is able to specify the destination by IP address and NID. The protocol stack in the computing device uses the NID to select the correct interface and therefore the correct network on which the data packet is to be sent, thereby avoiding the problem with the same IP address appearing on more than one network. If two interfaces have the same NID, as with the configuration shown in FIG. 2, the stack can pick either interface because both are connected to the same network as represented by the same or common ID. The NID is then stripped off before the socket information is put into the packet headers and sent off.

An example of this transformation of outgoing data packets may be as follows.

A packet leaving the application can be represented as follows:

| | | | | | |
|---|---|---|---|---|---|
| src addr | src port | dst addr | dst port | NID = 2 | Data |

| | | | |
|---|---|---|---|
| 192.168.1.1 | 66 | 192.168.1.2 | 66 |

However, because the NID is stripped from the data packet before dispatch, the same packet leaves actually leaves the device in the following format:

| src addr | src port | dst addr | dst port | Data |
|---|---|---|---|---|
| 192.168.1.1 | 66 | 192.168.1.2 | 66 | |

Normally, applications will not need to know about the NID when they are responding to an incoming packet; if the socket that will be used for sending data is created from a listening socket the new socket will be created with the right NID.

FIG. 3 illustrates an example of a computing device architecture suitable for incorporating this invention into any operating system where a common protocol stack is used to allow multiple applications to make use of multiple network interfaces, PDP contexts or their logical equivalents. The architecture 30 includes an interface manager 32 connected to three network interfaces, indicated as Interface 1, Interface 2, and Interface 3 in FIG. 3, which are respectively accorded network identifiers NID 1, NID 2, and NID 3. The architecture includes a storage device, such as a hard disc drive 34 as shown in FIG. 3, which is used to store information indicative of the associations between the NIDs, the networks and the interfaces. The architecture also includes a communications protocol stack 36 which can communicate with a number of applications, such as Applications 1 and 2 shown in FIG. 3.

The interface manager 32 functions to assign NIDs to incoming data packets and also to strip assigned NIDs from outgoing data packets. Hence, as an example, a data packet arriving on the network coupled to Interface 1 would be assigned NID=1. The incoming data packet, including this NID, is routed through the communications protocol stack 36 to the required application. The application concerned can then respond to the incoming data packet in the usual manner. When the application requires to respond by sending an outgoing data packet onto the same network as the received packet, the NID which has been assigned by the interface manager is used to direct the outgoing packet to Interface 1, and therefore onto the correct network, but before the packet is actually routed to interface 1, the NID is stripped from the data packet so the packet exits the device in the format as described above.

It can be realised from the above description that this invention provides a computing device user with the ability to connect to different networks simultaneously without any address ambiguity problems, thereby overcoming the disadvantages associated with the current methodology. Furthermore, the invention can be used in any networked device that connects to multiple networks.

Although the present invention has been described with reference to particular embodiments, it will be appreciated that modifications may be effected whilst, remaining within the scope of the present invention as defined by the appended claims.

1. A method of providing Internet Protocol private network addresses on a computing device which maintains multiple interfaces, each of which may be connected to different local area networks, the method comprising embedding a respective unique identifier for each of the said local area networks in the Internet Protocol address structure.

2. A method according to claim 1 where the computing device maintains a database mapping interfaces to the networks.

3. A method according to claim 1 wherein the computing device is arranged to remove the unique identifier from the address structure before data is placed onto a network by the computing device.

4. A computing device arranged to operate in accordance with a method as claimed in claim 1.

5. An operating system for causing a computing device to operate in accordance with a method as claimed in claim 1.

6. A method according to claim 2 wherein the computing device is arranged to remove the unique identifier from the address structure before data is placed onto a network by the computing device.

7. A computing device arranged to operate in accordance with a method as claimed in claim 2.

8. A computing device arranged to operate in accordance with a method as claimed in claim 3.

9. An operating system for causing a computing device to operate in accordance with a method as claimed in claim 2.

10. An operating system for causing a computing device to operate in accordance with a method as claimed in claim 3.
